(19) United States
(12) Patent Application Publication
(10) Pub. No.: US 2011/0220827 A1
(43) Pub. Date: Sep. 15, 2011

(54) FAUCET HANDLE CONNECTOR

(75) Inventors: Michael J. Tortorello, Oak Lawn, IL (US); Michael A. Mayer, Chicago, IL (US)

(73) Assignee: Elkay Manufacturing Company, Oak Brook, IL (US)

(21) Appl. No.: 12/721,756

(22) Filed: Mar. 11, 2010

(51) Int. Cl. F16K 31/44; F16K 51/00

(52) U.S. Cl. 251/231; 137/15.18

(57) ABSTRACT

A faucet handle connector that securely attaches a grip of a faucet handle to a valve apparatus for regulating the flow rate and/or temperature of water through a faucet spout. The faucet handle connector provides a structure for convenient attachment of the faucet handle to the valve apparatus. In addition, the faucet handle connector attaches the faucet handle to the valve apparatus in a manner that conceals the faucet handle connector from a user to improve the aesthetic characteristics of the faucet and to reduce the number of parts required for assembly. Thus, the faucet handle connector attaches the faucet handle to the valve apparatus without the use of a screw or any other observable fastener, and a separate cover or similar structure is not required to hide the connector.

### BACKGROUND

Faucets typically include a spout that serves as an exit conduit for a flow of water from a supply pipe, and one or more handles that control the flow and/or temperature of the water. The handle is attached to a valve apparatus that is opened and closed when the handle is moved. The handle is typically coupled to the valve apparatus with a screw. Often, the screw head is left exposed to the user, but is sometimes covered with a detachable, decorative plate in an attempt to conceal the screw head from the user.

### BRIEF SUMMARY

A faucet handle connector is disclosed that securely attaches a grip of a faucet handle to a valve apparatus for regulating the flow rate and/or temperature of water through a faucet spout. The faucet handle connector provides a structure for convenient attachment of the faucet handle to the valve apparatus. In addition, the faucet handle connector attaches the faucet handle to the valve apparatus in a manner that hides the faucet handle connector from a user of the faucet to improve the aesthetic characteristics of the faucet and to reduce the number of parts required for assembly. Thus, the faucet handle connector attaches the faucet handle to the valve apparatus without the use of a screw or any other observable fastener, and a separate cover or similar structure is not required to conceal the connector.

A faucet handle for operating a valve apparatus is disclosed that comprises a grip, a connector, and a base. The grip is for user-activation of the valve apparatus. The connector is coupled to the grip, and the connector has a groove and a snap washer disposed within the groove. The base has an internal detent, and the base receives the connector such that the snap washer engages the detent.

In addition, a connector for a faucet handle is disclosed that comprises a connector body, a groove, and a snap washer. The connector body is for attachment to a faucet grip and a faucet base. The groove is disposed in the connector body, and the snap washer is disposed in the groove for engaging a detent in a faucet base.

Further, a method of assembling a faucet handle is disclosed. The method comprises: (1) providing a faucet handle having a grip, a connector with a snap washer disposed in a groove, and a base with an internal detent; (2) disposing the base on at least one of a counter and a sink rim; and (3) inserting the connector into the base such that the snap washer engages the detent to retain the connector and grip to the base.

### BRIEF DESCRIPTION OF THE DRAWINGS

FIG. 1 is a perspective view of a faucet handle attached to a valve apparatus;

FIG. 2 is a top plan view of the faucet handle of FIG. 1;

FIG. 3 is an exploded perspective view of the faucet handle and valve apparatus of FIG. 1;

FIG. 4 is a partial cross-sectional view taken through line 4-4 in FIG. 2 of the faucet handle and valve apparatus of FIG. 1;

FIG. 5 is an exploded perspective view of another embodiment of a faucet handle and valve apparatus; and

FIG. 6 is a partial cross-sectional view of the faucet handle and valve apparatus of FIG. 5.

### DETAILED DESCRIPTION

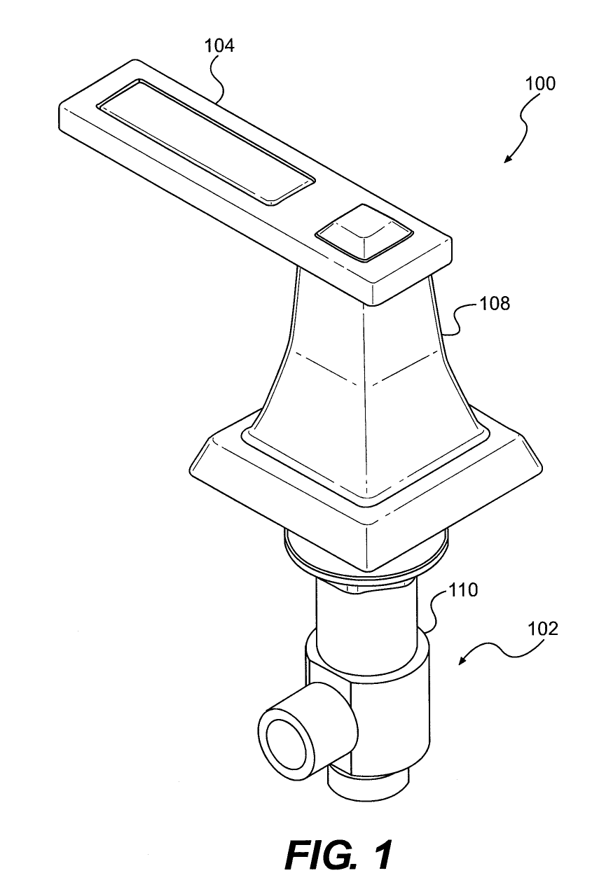

Referring to the figures, a representative faucet handle 100 for a faucet is shown in FIG. 1. The faucet handle 100 is coupled to a valve apparatus 102. The valve apparatus 102 is used to regulate the flow rate and/or temperature of water flowing through a faucet. A user activates and controls the valve apparatus 102 by moving the faucet handle 100 in a suitable manner. The movement can be in any suitable direction depending on the constructions of the valve apparatus 102 and the faucet handle 100. In addition, the valve apparatus 102 can have any suitable construction for regulating the flow rate and/or temperature of water flowing through a faucet.

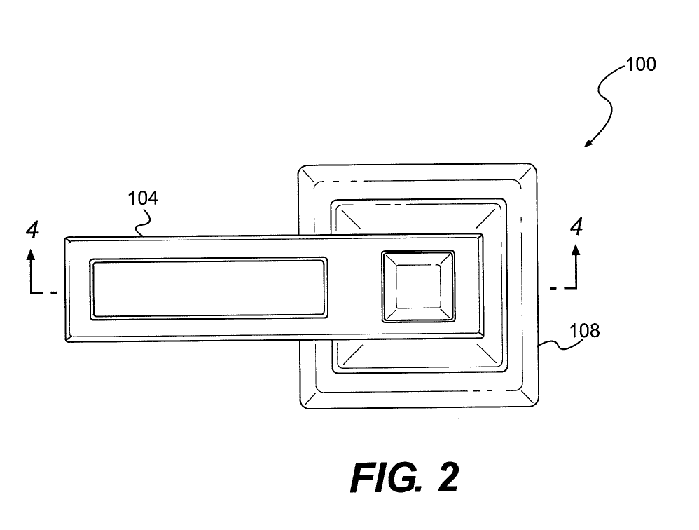

Referring to FIGS. 1-3, the faucet handle 100 can include a structure for user activation, which can be movably coupled to a stationary portion. More specifically, the faucet handle 100 can include a grip 104 for a user to grasp in order to move the faucet handle 100. The faucet handle 100 can also include a connector 106 that extends from the grip 104. As described further below, the connector 106 couples the grip 104 to an escutcheon/base 108 that is securely mounted to a sink and/or a countertop. Ornamental characteristics, such as shape and color, of the grip 104 and base 108 are generally selected for their aesthetic appeal. It will be appreciated that the faucet handle 100 can have any suitable shape and aesthetic characteristics.

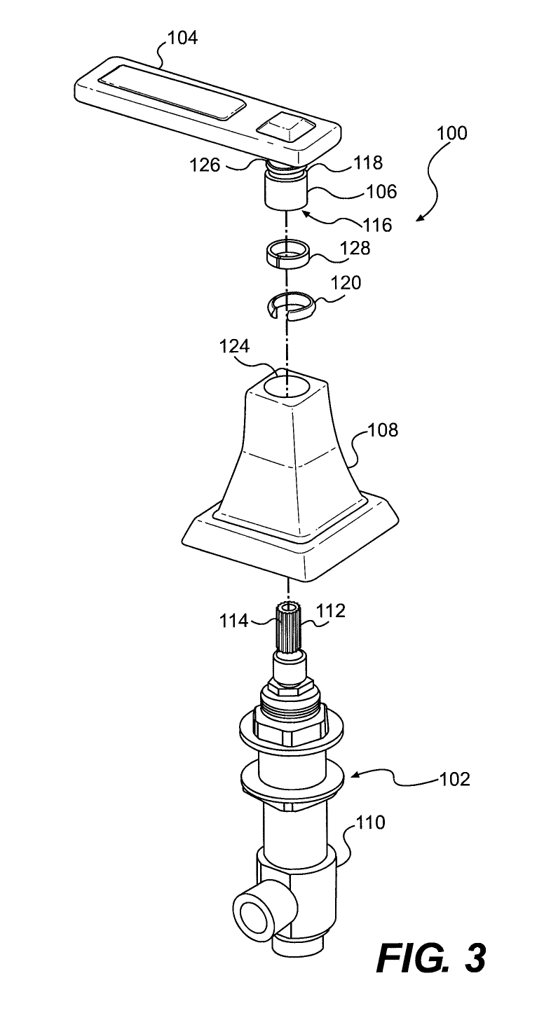

The valve apparatus 102 can have a housing 110 and a stem 112. The faucet handle 100 can engage the stem 112 to actuate the valve apparatus 102. As shown in FIG. 3, the stem 112 extends from the housing 110 and can include a projection 114, having one or more teeth, that can be engaged by a corresponding receiving portion 116 of the connector 106. The receiving portion 116 can include one or more recesses for engaging the one or more teeth of the stem 112. In the illustrated embodiment, the stem 112 is rotated when the grip 104 is rotated by a user. It will be appreciated that the stem 112 may have any suitable structure such that it can be engaged by the faucet handle 100 to actuate the valve apparatus.

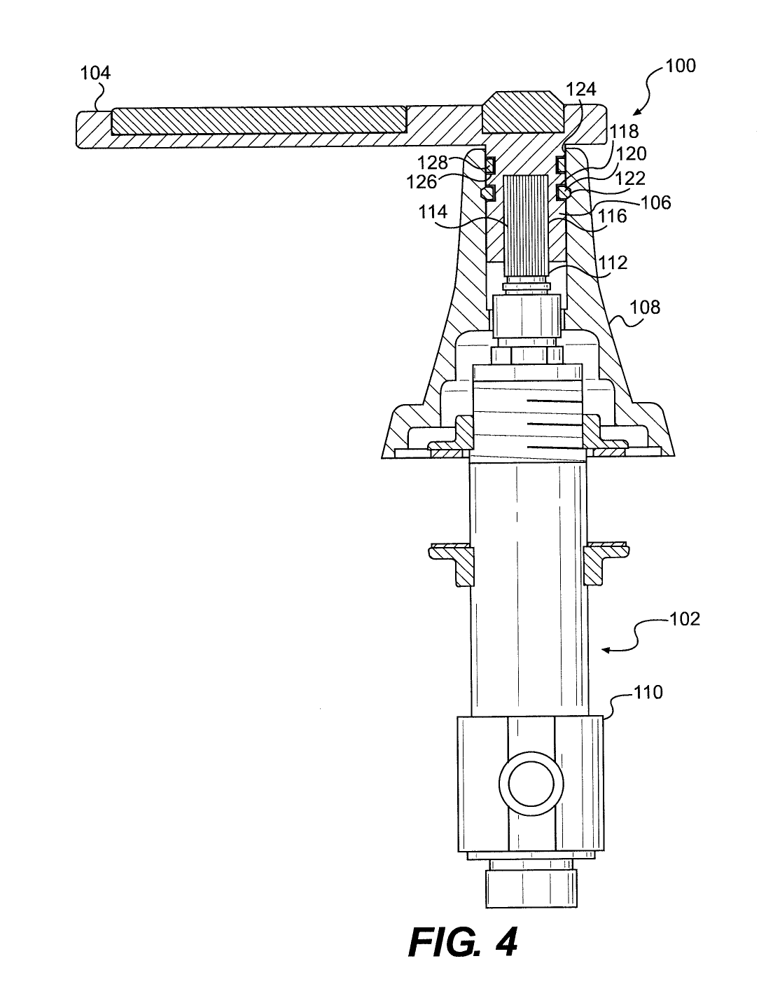

As mentioned above, referring to FIGS. 3 and 4, the faucet handle 100 can include a connector 106 that quickly and reliably secures the grip 104 to the base 108, while also permitting the faucet handle 100 to moveably engage the stem 112 of the valve apparatus 102. The connector 106 can include a groove 118 formed in its body for retaining a snap washer 120, and the interior of the base 108 can include an annular detent 122 for receiving the snap washer 120. The snap washer 120 can be generally ring-shaped with a discontinuity permitting the snap washer 120 to be compressed. The snap washer 120 is dimensioned such that it fits partially within the groove 118, and the snap washer 120 has an interior diameter that is larger than the interior diameter of the groove 118 to provide freedom of movement for the snap washer 120 when compressed.

The connector 106 can be attached to the base 108 by inserting the connector 106 into a cylindrical opening 124 in the base 108. The outer surface of the snap washer 120 can be tapered such that as the connector 106 is moved toward the cylindrical opening 124, the perimeter of the base 108 defining the opening 124 makes contact with the outer surface of the snap washer 120 and gradually compresses snap washer 120 until it fits within the cylindrical opening 124. The connector 106 is inserted into the cylindrical opening 124 until the snap washer 120 reaches the detent 122. At that position, the snap washer 120 expands outward into the detent 122. With the snap washer 120 engaging both the groove 118 and the detent 122, the grip 104 is securely coupled to the base 108.

The grip 104 is removable from the base 108 by exerting a sufficient force on the grip 104 in a direction away from the cylindrical opening 124, upward as oriented in FIG. 4, to force the snap washer 120 to compress further into the groove 118 such that the snap washer 120 can move past the detent 122. Once this occurs, the connector 106 can freely slide out of the cylindrical opening 124.

The connector 106 may be fitted with additional features that enhance the fit of the connector 106 within the base 108. For example, the connector 106 may have one or more additional grooves 126 for receiving a wear washer 128. The wear washer 128 can be generally ring-shaped. When the connector 106 is coupled to the base 108, the wear washer 128 can provide a close and secure fit between the base 108 and the connector 106. The wear washer 128 also provides a secondary point of contact between the connector 106 and the base 108 to stabilize the attachment between these components. The secondary point of contact provided by the wear washer 128 restricts the connector 106 from shifting side-to-side within the cylindrical opening 124, thus avoiding any significant rocking motion of the grip 104.

Using the connector 106, the grip 104 may be quickly and securely attached to the base 108 without the use of a separate fastener, such as a screw. When using the connector 106, the faucet handle 100 can be constructed such that there is no visible indication to a user that the grip 104 is separable from the base 108. Thus, the connector 106 provides a way to couple the grip 104 to the base 108 without adversely affecting the aesthetic appearance of the faucet handle 100 or utilizing any additional features to hide the connector 106 or other fastener from a user.

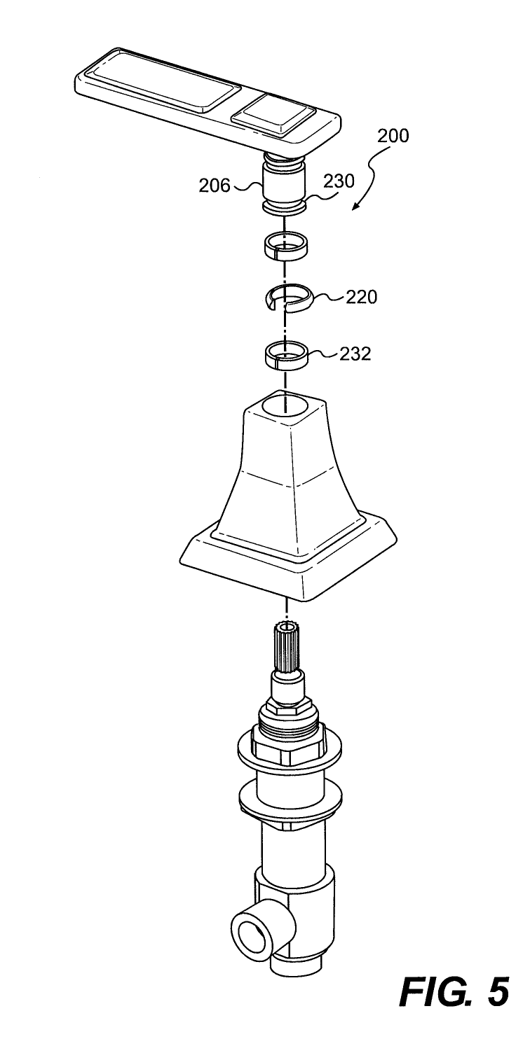

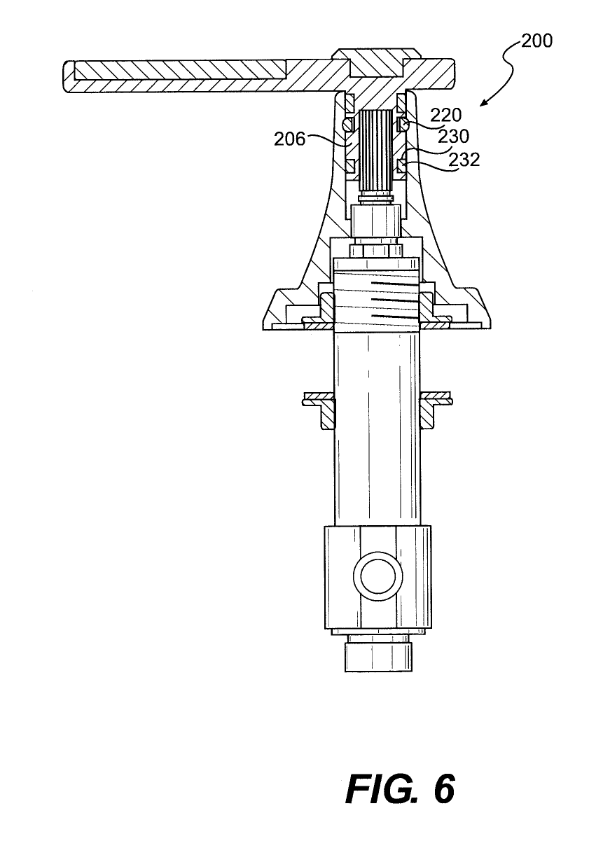

As shown in FIGS. 3 and 4, a wear washer 128 may be disposed between the grip 104 and the snap washer 120 near the edge forming the perimeter of the cylindrical opening 124 in the base 108. As shown in FIGS. 5 and 6, faucet handle 200 may have a connector 206 with an additional groove 230 for receiving a second wear washer 232 disposed between the snap washer 220 and the counter or sink rim.

It will be appreciated that the connector may have any suitable number of snap washers and wear washers disposed in any suitable orientation on the connector. Although the illustrated embodiments show the snap washer and wear washer attached to the connector, it will be appreciated that a snap washer and/or wear washer may be attached to the interior of the base, and the snap washer may engage a detent in the connector. It will also be appreciated that the snap washer and wear washer can be any suitable shape and can be constructed of any suitable material including, but not limited to, an acetal based plastic such as Delrin®.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A faucet handle for operating a valve apparatus comprising:
a grip for user-activation of the valve apparatus;
a connector coupled to the grip, the connector having a groove and a snap washer disposed within the groove; and
a base, the base having an internal detent, the base receiving the connector such that the snap washer engages the detent.

2. The faucet handle of claim 1 further comprising a wear washer disposed on the connector.

3. The faucet handle of claim 2 wherein the wear washer is disposed on the connector between the snap washer and the grip.

4. The faucet handle of claim 2 wherein the wear washer is disposed in a second groove on the connector.

5. The faucet handle of claim 1 wherein the snap washer is generally ring-shaped.

6. The faucet handle of claim 1 wherein the grip and connector are removable from the base by disengaging the snap washer from the detent.

7. The faucet handle of claim 1 wherein the connector has a receiving portion for receiving a stem of the valve apparatus.

8. The faucet handle of claim 1 wherein the connector is integral with the grip.

9. The faucet handle of claim 1 wherein the snap washer has a tapered exterior surface.

10. The faucet handle of claim 1 wherein the snap washer is compressible and expandable.

11. A connector for a faucet handle comprising:
a connector body for attachment to a faucet grip and a faucet base;
a groove disposed in the connector body; and
a snap washer disposed in the groove for engaging a detent in the faucet base.

12. The connector of claim 11 further comprising a wear washer.

13. The connector of claim 12 wherein the wear washer is disposed in a second groove on the connector.

14. The connector of claim 11 wherein the snap washer is generally ring-shaped.

15. The connector of claim 11 further comprising a receiving portion for receiving a stem of a valve apparatus.

16. The connector of claim 11 wherein the snap washer has a tapered exterior surface.

17. The connector of claim 11 wherein the snap washer is compressible and expandable.

18. A method of assembling a faucet handle comprising:
providing a faucet handle having a grip, a connector having a snap washer disposed in a groove, and a base having an internal detent;
disposing the base on at least one of a counter and a sink rim; and
inserting the connector into the base such that the snap washer engages the detent to retain the connector and grip to the base.

19. The method of claim 18 further comprising a valve apparatus, the valve apparatus including a stem for operating the valve apparatus, and wherein the connector engages the stem when the connector is inserted into the base.

20. The method of claim 18 wherein the connector includes a wear washer and a second groove, and the wear washer is disposed in the second groove.
